(19) United States
(12) Patent Application Publication
(10) Pub. No.: US 2010/0058233 A1
(43) Pub. Date: Mar. 4, 2010

(54) DISCOVERING NEW FEATURES IN AN APPLICATION GUI

(75) Inventors: Allen V. Chan, Markham (CA); Perry R. Giffen, Kemptville (CA); Jung W. Van, Richmond Hill (CA); Grace P. Wong, North York (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/199,514

(22) Filed: Aug. 27, 2008

(51) Int. Cl. G06F 3/048; G06F 3/00

(52) U.S. Cl. 715/810; 715/700; 715/808

(57) ABSTRACT

Embodiments of the present invention provide a method, system and computer program product for discovering new features in an application graphical user interface (GUI). In an embodiment of the invention, a method for discovering new features in an application GUI can be provided. The method can include determining a correspondence between a GUI element in a GUI for a computing application and a new feature for the computing application, annotating the GUI element with a new feature indicia, and removing the new feature indicia once the GUI element has been accessed.

### BACKGROUND OF THE INVENTION

1. Field of the Invention

The present invention relates to the field of user interface management for a complex computing application and more particularly to new feature emphasis in an application user interface.

2. Description of the Related Art

The use of computing tools to automate manual tasks enjoyed only gradual growth prior to the advent of the graphical user interface (GUI). The modern GUI, however, drove explosive growth in the adoption of computer software as an indispensable tool for the common user. As a result, computing applications evolved from simple, focused products to massively complex systems in which a bevy of features enabled end users to accomplish multiple, interrelated tasks. In the former instance, little documentation had been required to express the capabilities of the application, as the capabilities were plainly evident from the organization of the user interface for the application. Yet, in the latter instance, substantial documentation complete with accessible index is required in order to explain each of the various features provided by the complex application.

As the skilled artisan will recognize, computing users oftentimes bypass the user manual in order to directly interact with the application. Whether end users find the review and digestion of documentation to be difficult, inconvenient or tedious, is inconsequential in that without a review of documentation, end users must rely on the user interface of an application to express the available features of the application. Most applications rely upon labeling of user interface elements—specifically buttons and menu bar entries, to express a capability of an underlying feature. Notwithstanding, some applications further provide pop-up dialogs and visual emphasis in the user interface to expressly call attention to new features available for use in an application.

In this regard, some applications track new features available for access in an application and periodically prompt the end user through a pop-up dialog box of the availability of the new feature. Other applications provide a pop-up dialog box as a “tip” only at start up of the application. In both cases, the application will cycle through a complete sequence of new features before repeating. Generally, applications provide a user preference permitting the end user to manual disable “tips” or “hints”. As a result, end users need not experience the continual annoyance of a tip that has been viewed many times, or that is already well-known to the end user.

Notwithstanding the widespread use of the “tip” or “hint” dialog box, new features are contextual in nature. Specifically, access to a new feature of an application has its greatest relevance at a time when an end user interacting with an application would benefit from use of the new feature. Providing a “tip” or “hint” only at the launch of the application provides little relevance for the end user. Further, randomly providing a “tip” or “hint” for a new feature at a pertinent user interface screen in an application, while providing relevance, does not account for whether or not the end user already is aware of the new feature and can act as screen clutter and an annoyance for the end user.

### BRIEF SUMMARY OF THE INVENTION

Embodiments of the present invention address deficiencies of the art in respect to new feature notification for a computing application and provide a novel and non-obvious method, system and computer program product for discovering new features in an application GUI. In an embodiment of the invention, a method for discovering new features in an application GUI can be provided. The method can include determining a correspondence between a GUI element in a GUI for a computing application and a new feature for the computing application, annotating the GUI element with a new feature indicia, and removing the new feature indicia once the GUI element has been accessed.

In an aspect of the embodiment, the method further can include detecting a proximity event for the GUI element and rendering a new feature pop-up with new feature information for the new feature in response to the proximity event only so long as the GUI element has not yet been accessed. In this regard, rendering a new feature pop-up with new feature information for the new feature in response to the proximity event can include rendering a new feature pop-up with both a brief description of the new feature and also a link to more detailed information for the new feature, in response to the proximity event. In another aspect of the embodiment, the method further can include maintaining a new feature list of new features and corresponding GUI elements in the GUI that have not yet been accessed removing selected new features from the new feature list once the selected new features have been accessed by an end user, and displaying the new feature list in the GUI.

In another embodiment of the invention, a data processing system can be configured for discovering new features in an application GUI. The system can include a computing application executing in a host computer, a GUI produced by the computing application to include GUI elements, and new feature discovery logic coupled to the application and GUI. The logic can include program code enabled to determine a correspondence between a selected GUI element amongst the GUI elements and a new feature for the computing application, to annotate the selected GUI element with a new feature indicia, and to optionally remove the new feature indicia once the selected GUI element has been accessed. Optionally the user should have a control to see all or not see all the feature indicia

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a screen shot sequence responsive to a process for discovering new features in an application GUI;

FIG. 2 is a schematic illustration of a data processing system configured for discovering new features in an application GUI; and,

FIG. 3 is a flow chart illustrating a process for discovering new features in an application GUI.

### DETAILED DESCRIPTION OF THE INVENTION

Embodiments of the present invention provide a method, system and computer program product for discovering new features in an application user interface. In accordance with an embodiment of the present invention, a listing of undiscovered features for a computing application can be maintained and GUI elements in a GUI for the computing application relating to the undiscovered features each can be annotated with a new feature indicia providing a visual cue drawing attention to the new feature. Further, the listing can be compared to a selection of a GUI element in a GUI such that if a selected GUI element has not yet been accessed, new feature information can be presented for the selected GUI element. Yet, once a GUI element associated with a new feature has been selected, a corresponding entry for the new feature can be removed from the listing and the new feature indicia can be removed display in association with the selected GUI element.

In this way, context can be provided for an indication of a new feature without creating a long term annoyance for an interacting end user. Further, an interactive learning experience can be provided to users of the computing application. Specifically, as will be apparent to one of skill in the art, interaction between the end user and the GUI permit the end user to explore and learn new features of a new version of the computing application added from a previous version of the computing application. Through the new feature information, the end user can interactively explore the new feature though the end user may not have been aware previously of the new feature. Accordingly, not only will the end user become aware of the new feature, but also the end user will be able to explore and understand the details of the new feature. Finally, discovering one new feature presented through the GUI can lead the end user to discover another related new features added in a new release of the computing application.

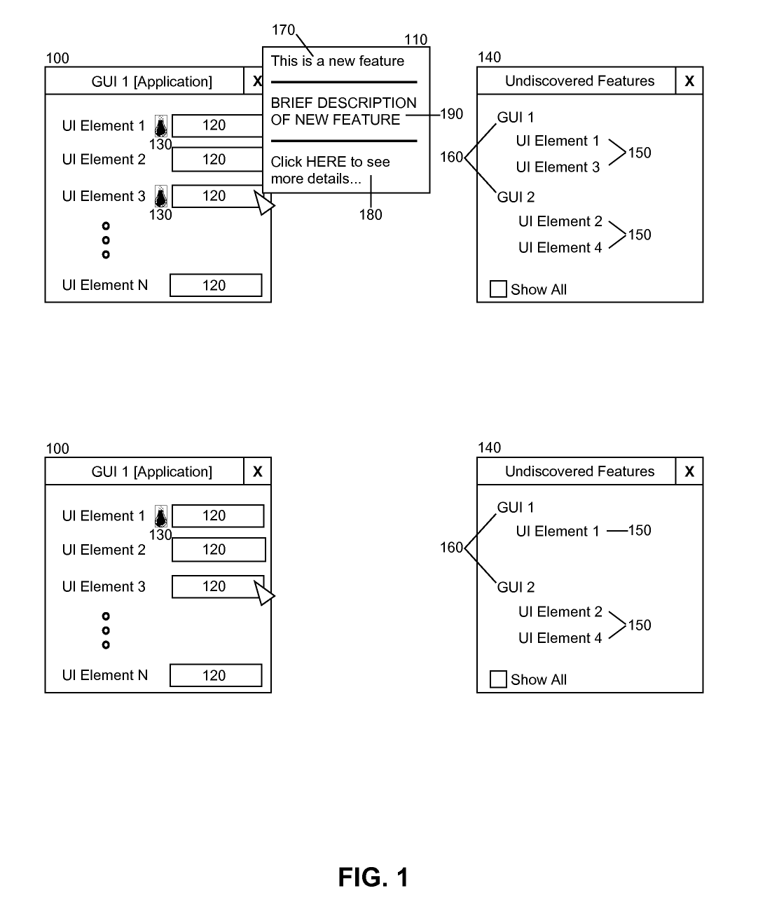

In further illustration, FIG. 1 is a pictorial illustration of a screen shot sequence responsive to a process for discovering new features in an application GUI. As shown in FIG. 1, a GUI 100 for a computing application can be provided to include one or more GUI elements 120 such as buttons, text entry fields, drop down lists, check boxes and the like. Notably, selected ones of the GUI elements 120 can be annotated with a new feature indicia 130 to indicate an association between the annotated ones of the GUI elements 120 and corresponding new features of the application accessible through the annotated ones of the GUI elements 120. However, as it will be apparent from the pictorial illustration of FIG. 1, once a new feature has been reviewed by an end user, for example, by accessing the new feature, the new feature indicia for the corresponding annotated one of the GUI elements 120 can be removed from the GUI 100.

As shown in FIG. 1, each of the annotated ones of the GUI elements 120 can be configured to respond to a proximity event such as a mouse-over or mouse or keyboard selection, by way of example. Specifically, in response to a proximity event for an annotated one of the GUI elements 120, a new feature pop-up 110 can be rendered providing new feature information 170, 180, 190 for a new feature associated with the annotated one of the GUI elements 120. For example, the new feature information 170, 180, 190 can include an indication 170 of the new feature, a brief description 190 of the new feature, and a link to a more detailed explanation 180 of the new feature. As in the case of the new feature indicia, the once a new feature has been reviewed by an end user, for example by viewing new feature pop-up 110, the corresponding annotated one of the GUI elements 120 can no longer respond to the proximity event with the new feature pop-up 110.

Finally, a separate undiscovered features dialog box 140 can be rendered on command for the computing application. The undiscovered features dialog box 140 can provide a GUI element listing 150 associated with corresponding new features that are yet to be discovered. Optionally, the GUI element listing 150 can be grouped by different GUI displays 160. Yet again, once a new feature has been reviewed by an end user, the corresponding GUI element listing 150 can be removed from the undiscovered features dialog box 140.

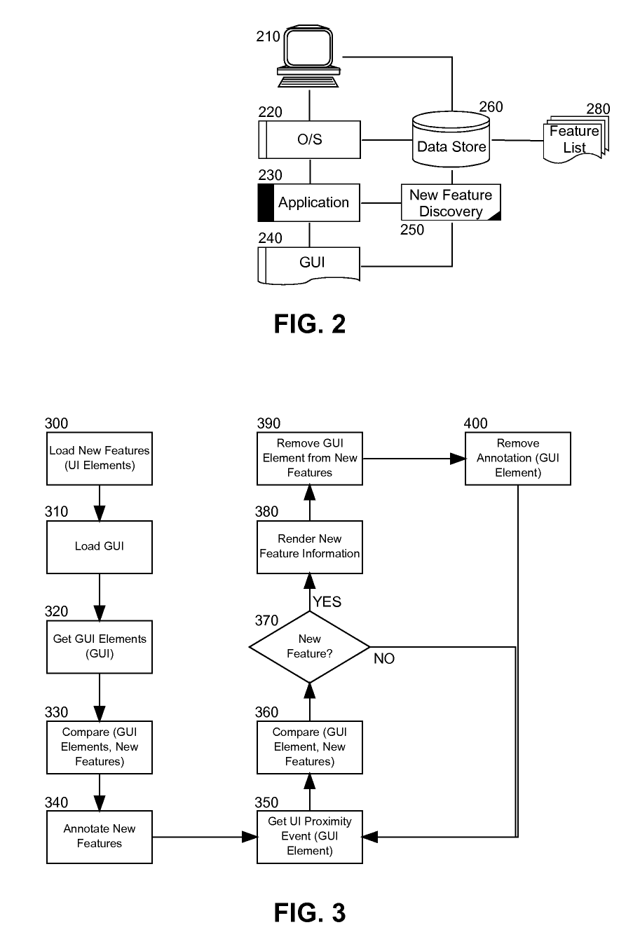

The process illustrated in FIG. 1 can be performed within a data processing system supporting the execution of a computing application. In illustration, FIG. 2 schematically shows a data processing system configured for discovering new features in an application GUI. The system can include a host computing platform 210 such as a personal computer supporting the operation of an operating system 220. The operating system 220 in turn can manage the execution of a computing application 230, whether the computing application 230 is stored in the host computing platform 210 or delivered for the execution in the host computing platform 210 over a computer communications network like the Internet.

The application 230 can produce multiple, different GUIs 240, though only a single GUI 240 has been shown for the purpose of illustrative simplicity. Each GUI 240 can include one or more GUI elements (not shown), for example buttons, text fields, checkboxes, images, static text, menus, drop down lists, and the like. Importantly, new feature discovery logic 250 can be coupled to the application 230 and GUI 240. The new feature discovery logic 250 can include program code enabled to maintain a new feature list 280 within data store 260, for example a database, markup language file or filebase. The new feature list 280 can include a listing of new features for the application 230 accessible through the GUI 240, but not yet accessed by an end user.

In operation, the new feature discovery logic 250 can compare the GUI elements in the GUI 240 to the new feature list 280 to identify GUI elements corresponding to new features in the new feature list 280. Thereafter, the new feature discovery logic 250 can annotate each of the GUI elements in the GUI 240 with a new feature indicia (not shown). Further, the new feature discovery logic 250 can present a new feature dialog box (not shown) in response to a proximity event detected for a GUI element in the GUI 240 corresponding to a new feature in the new feature list 280. Even yet further, the new feature discovery logic 250 can maintain a separate graphical display of the new feature list 280, for example grouped according to a respective GUI in which a GUI element corresponding to each new feature resides.

However, when a new feature corresponding to a GUI element in the GUI 240 is removed from the new feature list 280 having been accessed by an end user, the feature discovery logic 250 can remove the new feature indicia for the GUI element from the GUI 240. Additionally, the feature discovery logic 250 can disable the presentation of the new feature dialog box responsive to a proximity event detected for a GUI element in the GUI 240 corresponding to the GUI element. Finally, the feature discovery logic 250 can remove the new feature from the new feature list 280.

In yet further illustration, FIG. 3 is a flow chart illustrating a process for discovering new features in an application GUI. Beginning in block 300, a new features list can be loaded listing different new features and corresponding GUI elements providing access to the new features. In block 310, a GUI can be loaded to include multiple different GUI elements. In block 320, the different GUI elements in the GUI can be identified and in block 330, the different GUI elements in the GUI can be compared to the new features list to select those GUI elements corresponding to the new features in the new features list. Thereafter, in block 340 the selected GUI elements can be annotated with new feature indicia.

In block 350, a proximity event can be detected in association with a GUI element in the GUI. In block 360, the associated GUI element can be compared to the new features list to determine whether or not the associated GUI elements corresponds to a new feature in the new features list in decision block 370. If so, in block 380, new feature information can be rendered in a pop-up box for the new feature and in block 390, corresponding feature in the new features list can be removed. As well, in block 400 the annotation associated with the associated GUI element can be removed from the GUI. Finally, the process can repeat in block 350 with the detection of another proximity event.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for discovering new features in an application graphical user interface (GUI), the method comprising:
determining a correspondence between a GUI element in a GUI for a computing application and a new feature for the computing application;
annotating the GUI element with a new feature indicia; and,
removing the new feature indicia once the GUI element has been accessed.

2. The method of claim 1, further comprising:
detecting a proximity event for the GUI element; and,
rendering a new feature pop-up with new feature information for the new feature in response to the proximity event only so long as the GUI element has not yet been accessed.

3. The method of claim 2, wherein rendering a new feature pop-up with new feature information for the new feature in response to the proximity event, comprises rendering a new feature pop-up with both a brief description of the new feature and also a link to more detailed information for the new feature, in response to the proximity event.

4. The method of claim 1, further comprising:
maintaining a new feature list of new features and corresponding GUI elements in the GUI that have not yet been accessed;
removing selected new features from the new feature list once the selected new features have been accessed by an end user; and,
displaying the new feature list in the GUI.

5. A data processing system configured for discovering new features in an application graphical user interface (GUI), the system comprising:
a computing application executing in a host computer;
a GUI produced by the computing application to include GUI elements; and,
new feature discovery logic coupled to the application and GUI, the logic comprising program code enabled to determine a correspondence between a selected GUI element amongst the GUI elements and a new feature for the computing application, to annotate the selected GUI element with a new feature indicia, and to remove the new feature indicia once the selected GUI element has been accessed.

6. A computer program product comprising a computer usable medium embodying computer usable program code for discovering new features in an application graphical user interface (GUI), the computer program product comprising:
computer usable program code for determining a correspondence between a GUI element in a GUI for a computing application and a new feature for the computing application;
computer usable program code for annotating the GUI element with a new feature indicia; and,
computer usable program code for removing the new feature indicia once the GUI element has been accessed.

7. The computer program product of claim 6, further comprising:
computer usable program code for detecting a proximity event for the GUI element; and,
computer usable program code for rendering a new feature pop-up with new feature information for the new feature in response to the proximity event only so long as the GUI element has not yet been accessed.

8. The computer program product of claim 7, wherein the computer usable program code for rendering a new feature pop-up with new feature information for the new feature in response to the proximity event, comprises computer usable program code for rendering a new feature pop-up with both a brief description of the new feature and also a link to more detailed information for the new feature, in response to the proximity event.

9. The computer program product of claim 6, further comprising:
computer usable program code for maintaining a new feature list of new features and corresponding GUI elements in the GUI that have not yet been accessed;
computer usable program code for removing selected new features from the new feature list once the selected new features have been accessed by an end user; and,
computer usable program code for displaying the new feature list in the GUI.
